(19) United States
(12) Patent Application Publication
(10) Pub. No.: US 2026/0054877 A1
(43) Pub. Date: Feb. 26, 2026

(54) AUTOMATED BULK BAG UNLOADING SYSTEM WITH AN AUTOMATED BLADE CUTTING SYSTEM

(71) Applicant: CMT Process Solutions, Inc., Charlotte, NC (US)

(72) Inventors: Scott Dahlgren, Charlottle, NC (US); Robert Kubinski, Monroe, NC (US); Liam Klotzbach, Clover, SC (US)

(21) Appl. No.: 19/305,943

(22) Filed: Aug. 21, 2025

Related U.S. Application Data
(60) Provisional application No. 63/685,863, filed on Aug. 22, 2024.

(51) Int. Cl. B65B 69/00; B65G 65/32

(52) U.S. Cl. CPC B65B 69/0008; B65G 65/32; B65G 2814/0302; B65G 2814/0314

(57) ABSTRACT

An automated bulk bag unloading system is configured for autonomously unloading bulk materials from a bulk bag into a hopper. The automated bulk bag unloading system includes a bag moving assembly and an automated cutting system. The bag moving assembly is configured to move the bulk bag from a loading location to a bag cutting area above the hopper. The automated cutting system is positioned over the hopper in the bag cutting area and includes at least one automated cutting device configured to cut open a bottom of the bulk bag while in position over the hopper. Wherein, when the bag moving assembly moves the bulk bag from the loading location to the bag cutting area over the hopper, and the automated cutting system cuts open the bottom, the bulk materials discharge out of the bottom of the bulk bag and drop into the hopper.

### CROSS-REFERENCE TO RELATED APPLICATIONS

This application claims benefit to U.S. Provisional Ser. No. 63/685,863 filed on Aug. 22, 2024, entitled AUTOMATED BULK BAG UNLOADING ASSEMBLY WITH AN AUTOMATED BLADE CUTTING SYSTEM, which is incorporated by reference in its entirety.

### FIELD OF THE DISCLOSURE

The present disclosure relates to the handling and processing of bulk bags. More specifically, the present disclosure is directed toward an automated bulk bag unloading system with an automated blade cutting system for opening the bottom of the bulk bag.

### BACKGROUND

Generally speaking, bulk bags, also referred to as FIBCs, Super Sacks and Big Bags can be used to transport or store materials, generally holding between 500-6,000 lbs. of product. The top of the bag can include an inlet, and the bottom of the bag can include a closed spout or flat bottom designed to hold the materials until emptying the contents of the bulk bag. Depending on the product stored within the bulk bags, bonds can form between particulates creating discharging issues. Accordingly, when the bottom of the bulk bag is later opened (e.g., via a spout or cutting the bag), then the bulk material will not flow and exit the bag.

There are a number of systems available to discharge a bulk bag, including spouted bags, where an operator must manipulate and untie the spout (i.e. opening the bag). Once untied, most products require bag stimulation for flow from the bag. External massagers or vibration is typically employed to aid in discharging.

“Single trip bags” are provided without a spout on the bottom of the bag. These bags are generally unloaded via a stationary knife assembly where the bag is set onto the knife to discharge product.

There is only one known automated bulk bag unloading system available internationally. This system utilizes a stationary knife, where the bag is set on to open/discharge product, similar to the “single trip bags” described above.

These configurations suffer from multiples drawbacks. Once bulk bags are filled, densified to provide a stable bag, shipped across hundreds or thousands of miles, the product within the bag can form bonds between particulates that make discharging very difficult.

In all cases an operator is required to physically connect the bulk bag to a bag adapter or bag holder, which is used to lift the bag with either a fork truck or hoist and trolley.

Spouted bags require operator interface with the bag which exposes them to potentially dangerous chemicals and serious health hazards. Additionally, almost universally, the operator must work outside his ‘power zone’ thereby creating injury potential.

The typical length of time to raise a bag to the proper position within the bulk bag frame, manipulate it, and then discharge the bag can take anywhere from 7-30 minutes per bag. This means that the number of bulk bags that can be discharged per hour is typically less than 10.

Therefore, a need exists for an advanced bulk bag unloading system that eliminates these issues and provides increased production levels.

The instant disclosure may be designed to address at least certain aspects of the problems or needs discussed above by providing the disclosed automated bulk bag unloading system with an automated blade cutting system.

### SUMMARY

The present disclosure may solve the aforementioned limitations of the currently available bulk bag unloading systems and methods, by providing the disclosed automated bulk bag unloading system with an automated blade cutting system. The disclosed automated bulk bag unloading system may be configured for autonomously unloading bulk materials from a bulk bag into a hopper. The automated bulk bag unloading system may include a bag moving assembly and an automated cutting system. The bag moving assembly may be configured to move the bulk bag filled with the bulk materials from a loading location to a bag cutting area above the hopper. The automated cutting system may be positioned over the hopper in the bag cutting area. The automated cutting system may include at least one motor driven or automated cutting device configured to cut open a bottom of the bulk bag filled with the bulk materials while in position over the hopper. Wherein, when the bag moving assembly moves the bulk bag filled with the bulk materials from the loading location to the bag cutting area over the hopper, and the automated cutting system cuts open the bottom of the bulk bag while in position over the hopper, the bulk materials from the bulk bag may discharge out of the bottom of the bulk bag and drop into the hopper.

One feature of the disclosed automated bulk bag unloading system may be that it can be configured to eliminate all operator interface in emptying the bulk bag. In other words, the disclosed automated bulk bag unloading system may be designed and configured for “Hands free” or “Operator free” operation from the time the bulk bag is set onto the infeed conveyor at loading location and/or the bag lifting conveyor.

Another feature of the disclosed automated bulk bag unloading system may be that it can allow for discharging of more than 10 of the bulk bags per hour. In select embodiments, the automated bulk bag unloading system may be configured to allow for discharging of more than 25 of the bulk bags per hour. In select possibly preferred embodiments, the automated bulk bag unloading system may be configured to allow for discharging of between 25 and 60 of the bulk bags per hour.

In select embodiments of the disclosed automated bulk bag unloading system, the automated cutting system may include a linear rotating blade and two stationary rotating blades. The linear rotating blade may be configured to cut the bottom of the bulk bag approximate a front edge of the bulk bag from approximate a first side edge of the bulk bag to approximate a second side edge of the bulk bag. The linear rotating blade may be mounted on a linear shaft with a drive unit configured to move the linear rotating blade from one side of the bulk bag to the other side of the bulk bag when set in position by the bag moving assembly. The two stationary rotating blades may be configured to cut the bottom of the bulk bag while the bottom of the bulk bag is moved over the two stationary rotating blades. In select embodiments, the two stationary rotating blades may be parallel to one another. In select embodiments, the two stationary rotating blades may include a first stationary rotating blade and a second stationary rotating blade. The first stationary rotating blade may be configured to cut the bottom of the bulk bag approximate to the first side edge. The second stationary rotating blade may be configured to cut the bottom of the bulk bag approximate to the second side edge. In select embodiments, the first stationary rotating blade may be parallel to the second stationary rotating blade. Wherein, the automated cutting system may be configured to automatically cut three sides of the bottom of the bulk bag thereby creating an openable flap portion of the bottom of the bulk bag. In select embodiments, the linear rotating blade and/or the two stationary rotating blades, or any other blades or cutting devices used in automated cutting system may be non-serrated blades. The non-serrated blade feature of the disclosed automated cutting system may be configured to minimize debris from the bulk bag from entering the hopper.

In select embodiments of the disclosed automated bulk bag unloading system, the bag moving assembly may include a bag lifting device at a lifting location. The bag lifting device may be configured to elevate the bulk bag to a height of the bag cutting area over the hopper. Wherein, the bag lifting device may include a bag lifting conveyor configured to move the bulk bag filled with the bulk materials onto and off the bag lifting device.

In select embodiments of the disclosed automated bulk bag unloading system, the bag moving assembly may include at least one infeed conveyor. The at least one infeed conveyor may be configured to introduce the bulk bag filled with the bulk materials from the loading location onto the bag lifting conveyor on the bag lifting device at the lifting location. The bag moving assembly may include any number of infeed conveyors, including multiple (like 20 or more) infeed conveyors in line configured to introduce the bulk bag filled with the bulk material from the loading location onto the bag lifting conveyor on the bag lifting device at the lifting location (if required). In select embodiments, and clearly not limited thereto, the bag moving assembly may include three infeed conveyors in line configured to introduce the bulk bag filled with the bulk materials from the loading location onto the bag lifting conveyor on the bag lifting device at the lifting location.

In select embodiments of the disclosed automated bulk bag unloading system, the bag moving assembly may include an automatic hopper transfer conveyor positioned in the bag cutting area over the hopper. The automatic hopper transfer conveyor is configured to transfer the bulk bag filled with the bulk materials from the bag lifting device through the bag cutting area over the hopper for cutting open the bottom of the bulk bag with the automated cutting system. In select embodiments, the automatic hopper transfer conveyor may include a gap. The gap may be configured to allow the linear rotating blade to traverse through the automatic hopper transfer conveyor for cutting the bottom of the bulk bag while positioned on the automatic hopper transfer conveyor.

Another feature of the disclosed automated bulk bag unloading system may be that the bag moving assembly can include a bag stabilizer device. The bag stabilizer device may be configured to secure and move the bulk bag through the bag cutting area over the hopper while the bottom of the bulk bag is being cut open by the automated cutting system and when the bulk materials are discharging out of the bottom of the bulk bag and into the hopper. In select embodiments of the disclosed automated bulk bag unloading system, a frame may be included. The frame may be configured to support the bag stabilizer device while securing and moving the bulk bag over the hopper. In select embodiments, the frame may include two linear rails configured for supporting the bag stabilizer device with the bulk bag filled with the bulk material over the hopper while moving linearly through the cutting area while the bottom of the bulk bag is being cut open by the automated cutting system and when the bulk materials are discharging out of the bottom of the bulk bag and into the hopper.

Another feature of the disclosed automated bulk bag unloading system may be that the bag moving assembly may further include an automatic hopper transfer conveyor. The automatic hopper transfer conveyor may be positioned in the bag cutting area over the hopper. The automatic hopper transfer conveyor and the bag stabilizer device may be synchronized together for moving the bulk bag through the bag cutting area over the hopper at the same pace and movement, and for moving the cut open bulk bag off of the automatic hopper transfer conveyor for discharging the bulk materials from the bulk bag into the hopper. In select embodiments, the automatic hopper transfer conveyor may be sized and positioned between the two stationary rotating blades configured to cut the bottom of the bulk bag while the bottom of the bulk bag is moved over the two stationary rotating blades via the automatic hopper transfer conveyor and the bag stabilizer device.

In select embodiments of the disclosed automated bulk bag unloading system, the bag stabilizer device may include a top member, a first side bracket and a second side bracket. The top member may have a width sized wider than the bulk bag. The first side bracket may extend down from the top member on a first end. The first side bracket may include at least one first side puncturing rod. Each of the at least one first side puncturing rod may be configured to move into and out of the first side bracket of the bag stabilizer device for puncturing the first side of the bulk bag. Wherein, when each of the at least one first side puncturing rod is moved into the bag stabilizer device, each of the at least one first side puncturing rod is configured to puncture a first side of the bulk bag for securing and holding the first side of the bulk bag while moving through the bag cutting area over the hopper. The second side bracket may extend down from the top member on a second end. The second side bracket may include at least one second side puncturing rod. Each of the at least one second side puncturing rod may be configured to move into and back out of the second side bracket of the bag stabilizer device for puncturing the first side of the bulk bag. Wherein, when each of the at least one second side puncturing rod is moved into the bag stabilizer device, each of the at least one second side puncturing rod may be configured to puncture a second side of the bulk bag for securing and holding the second side of the bulk bag while moving through the bag cutting area over the hopper. The bag stabilizer device may include any number, shape or configuration of the first side puncturing rods and the second side puncturing rods included with the bag stabilizer device. In select embodiments, the first side bracket of the bag stabilizer device may include multiple, including four first side puncturing rods in a horizontal diamond shape configuration configured to stabilize the first side of the bulk bag. In other select embodiments, each of the first side puncturing rods may include a pointed tip. In other select embodiments, the second side bracket of the bag stabilizer device may include multiple, including four, second side puncturing rods in the horizontal diamond shape configuration configured to stabilize the second side of the bulk bag. In select embodiments, each of the four second side puncturing rods may include the pointed tip.

Another feature of the disclosed automatic bulk bag unloader system may be that when the automated cutting system cuts open the bottom of the bulk bag while in position over the hopper and the bulk materials from the bulk bag automatically empty into the hopper through the bottom of the bulk bag that is cut open, the bag stabilizer device may be configured to move the emptied bulk bag from over the hopper. In select embodiments, when the bag stabilizer device moves the emptied bulk bag from over the hopper, the bag stabilizer device is configured to drop the emptied bulk bag by moving each of the at least one first side puncturing rod from the first side of the bulk bag and moving each of the at least one second side puncturing rod from the second side of the bulk bag.

In select embodiments of the disclosed automatic bulk bag unloader system, a bag waste container may also be included. The bag waste container may be a waste bin, baler, compactor, or the like. Wherein, when the bag stabilizer device moves the emptied bulk bag from over the hopper, the bag stabilizer device may be configured to move the emptied bulk bag over the bag waste container and drop the emptied bulk bag into the bag waste container, like for disposing, baling or compacting the emptied bulk bag.

In select embodiments of the disclosed automated bulk bag unloading system, the hopper may include a surge hopper. The surge hopper may include the automated cutting system integrally coupled therein. Wherein, the automated cutting system may be configured to cut the bottom of the bulk bag allowing the bulk material to discharge directly into the surge hopper. Wherein, the surge hopper may be configured to store the contents and discharge the bulk material product through downstream equipment to meet process requirements.

Another feature of the disclosed automated bulk bag unloading system may be that it can be controlled via a control system. The control system may be configured to control the entire automated bulk bag unloading system, including, but not limited to, safety inputs, conveyors, lifts, the bag stabilizer device, the driven cutting blade(s), etc. As such, the control system may be designed and configured to control the automated cutting system including the at least one motor driven or automated cutting device of the automated cutting system to ensure the bottom of the bulk bag is opened allowing for discharge of the bulk material from the bottom of the bulk bag.

In select embodiments of the automated bulk bag unloading system, the entire automated bulk bag unloading system may be fully enclosed for operator safety and/or dust control.

In select embodiments of the automated bulk bag unloading system, the automated bulk bag unloading system may further include a dust collection assembly. The dust collection assembly may be configured for collecting dust or loose materials from in and around the bulk bag and the bag cutting area before and while being emptied into the hopper.

In another aspect, the instant disclosure embraces the automated bulk bag unloading system in any embodiments and/or combination of embodiments shown and/or described herein.

In another aspect, the instant disclosure embraces a method of automatically discharging a bulk bag filled with bulk materials. The disclosed method of automatically discharging a bulk bag filled with bulk materials may generally include utilizing the disclosed automated bulk bag unloading system in any embodiments and/or combination of embodiments shown and/or described herein. As such, the disclosed method of automatically discharging a bulk bag filled with bulk materials may generally include providing the disclosed automated bulk bag unloading system for autonomously unloading the bulk materials from the bulk bag into a hopper, where the automated bulk bag unloading system generally includes the bag moving assembly and the automated cutting system. The bag moving assembly may be configured to move the bulk bag filled with the bulk materials from a loading location to a bag cutting area above the hopper. The automated cutting system may be positioned over the hopper in the bag cutting area. The automated cutting system may include at least one motor driven or automated cutting device configured to cut open a bottom of the bulk bag filled with the bulk materials while in position over the hopper. Wherein, with the provided automated bulk bag unloading system, the disclosed method of automatically discharging a bulk bag filled with bulk materials may further include: moving the bulk bag filled with the bulk materials from the loading location to the bag cutting area over the hopper via the bag moving assembly; cutting open the bottom of the bulk bag while in position over the hopper via the automated cutting system; discharging the bulk materials out of the cut open bottom of the bulk bag; and dropping the bulk materials from the cut open bottom of the bulk bag into the hopper.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a back-left isometric view of the automated bulk bag unloading system according to select embodiments of the instant disclosure;

FIG. 2 is back-right isometric view of the automated bulk bag unloading system from FIG. 1;

FIG. 3 is a top view of the automated bulk bag unloading system from FIG. 1;

FIG. 4 is a left side view of the automated bulk bag unloading system from FIG. 1;

FIG. 5 is a right side view of the automated bulk bag unloading system from FIG. 1;

FIG. 6 is a back side view of the automated bulk bag unloading system from FIG. 1;

FIG. 7 is a front side view of the automated bulk bag unloading system from FIG. 1;

FIG. 8 is a back-left isometric view of the automated bulk bag unloading system according to select embodiments of the instant disclosure with a fork lift machine loading a bulk bag onto the infeed conveyors at the loading location;

FIG. 9 is a left side view of the automated bulk bag unloading system according to select embodiments of the instant disclosure with showing the bulk bag moving from the infeed conveyors to the lifting conveyor on the lifting device;

FIG. 10 is a left side view of the automated bulk bag unloading system according to select embodiments of the instant disclosure showing the bulk bag lifted to the height of the bag cutting area over the hopper via the lifting device;

FIG. 11 is a left side view of the automated bulk bag unloading system according to select embodiments of the instant disclosure with the bulk bag moving from the lifting conveyor to the automatic hopper transfer conveyor in the bag cutting area over the hopper;

FIG. 12 is a back-left isometric view of the automated bulk bag unloading system according to select embodiments of the instant disclosure with portions of the frame removed showing the bulk bag in position on the automatic hopper transfer conveyor for the bag stabilizer device to secure the bulk bag on the automatic hopper transfer conveyor;

FIG. 13 is a back-left isometric view of the automated bulk bag unloading system according to select embodiments of the instant disclosure with portions of the frame removed showing the bag stabilizer device securing the bulk bag on the automatic hopper transfer conveyor by puncturing the sides of the bulk bag with the first and second side puncturing rods;

FIG. 14 is a zoomed-in front side view of the automated bulk bag unloading system according to select embodiments of the instant disclosure showing the bag stabilizer device securing the bulk bag on the automatic hopper transfer conveyor by puncturing the sides of the bulk bag with the first and second side puncturing rods and also shows the linear (transverse direction) rotating blade in position on the side of the bulk bag;

FIG. 15 is a zoomed-in back-left isometric view of the automated bulk bag unloading system according to select embodiments of the instant disclosure with portions of the frame removed showing the bulk bag on the automatic hopper transfer conveyor and secured by the bag stabilizer device and in position for the linear (transverse direction) rotating blade to make a cut along the transverse direction of the leading or front edge of the bottom of the bulk bag;

FIG. 16 is a zoomed-in front view of the automated bulk bag unloading system according to select embodiments of the instant disclosure showing the bulk bag on the automatic hopper transfer conveyor and secured by the bag stabilizer device with the linear (transverse direction) rotating blade making the cut along the transverse direction of the leading or front edge of the bottom of the bulk bag;

FIG. 17 is a zoomed-in back-left isometric view of the automated bulk bag unloading system according to select embodiments of the instant disclosure with portions of the frame removed showing the bulk bag on the automatic hopper transfer conveyor and secured by the bag stabilizer device with the linear (transverse direction) rotating blade making the cut along the transverse direction of the leading or front edge of the bottom of the bulk bag;

FIG. 18 is a zoomed-in back-left isometric view of the automated bulk bag unloading system according to select embodiments of the instant disclosure with portions of the frame removed showing the bulk bag on the automatic hopper transfer conveyor after being cut by the linear (transverse direction) rotating blade on the leading or front edge of the bottom of the bulk bag moving further along the automatic hopper transfer conveyor with the two stationary (machine direction) rotating blades making cuts along the machine direction of both sides of the bottom of the bulk bag;

FIG. 19 is a zoomed-in back-left isometric view of the automated bulk bag unloading system according to select embodiments of the instant disclosure with portions of the frame removed showing the bulk bag on the automatic hopper transfer conveyor moving further along the automatic hopper transfer conveyor with the two stationary (machine direction) cutting blades finishing the cuts along the machine direction of both sides of the bottom of the bulk bag;

FIG. 20A is a back-left isometric view of the automated bulk bag unloading system according to select embodiments of the instant disclosure with portions of the frame removed showing the bulk bag moving off of the automatic hopper transfer conveyor after being cut by the two stationary (machine direction) cutting blades along the machine direction of both sides of the bottom of the bulk bag, where the bag stabilizer device is holding the bulk bag over the hopper and the openable flap portion of the bottom of the bulk bag is open;

FIG. 20B is a back-left isometric view of the automated bulk bag unloading system according to select embodiments of the instant disclosure with portions of the frame removed showing the bag stabilizer device holding the bulk bag over the hopper and the openable flap portion of the bottom of the bulk bag is opened and the bulk materials are discharging or falling out of the bottom of the bulk bag and into the hopper;

FIG. 21 is a back-left isometric view of the automated bulk bag unloading system according to select embodiments of the instant disclosure with portions of the frame removed showing the emptied bulk bag moved over the bag waste container via the bag stabilizer device;

FIG. 22 is a back view of the automated bulk bag unloading system according to select embodiments of the instant disclosure with portions of the frame removed showing the bulk bag positioned over the bag waste container and the bag stabilizer device releasing the bulk bag; and

FIG. 23 is a back-left isometric view of the automated bulk bag unloading system according to select embodiments of the instant disclosure with portions the frame removed showing the bulk bag falling into the bag waste container after being released by the bag stabilizer device.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

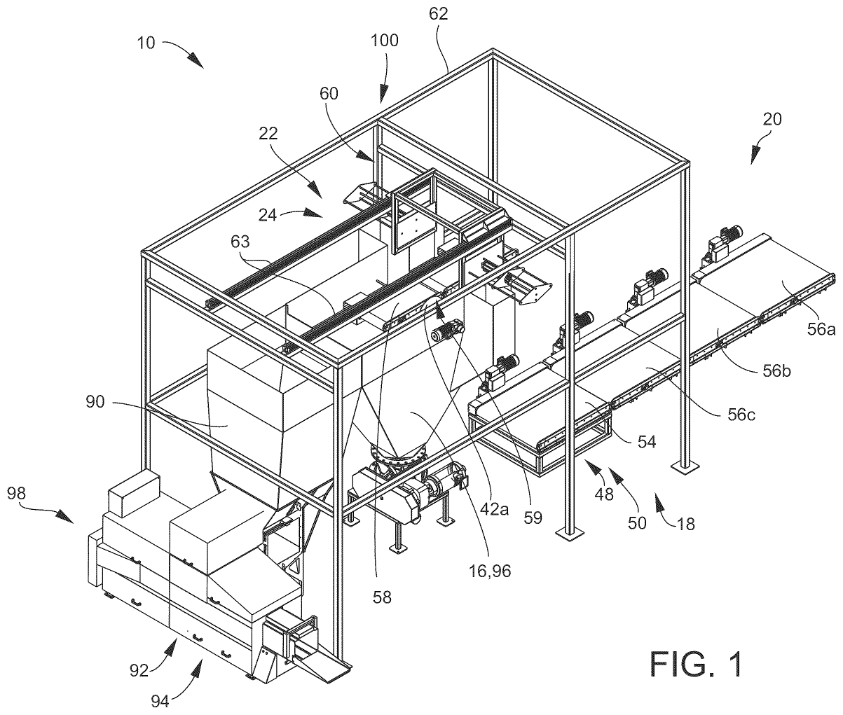

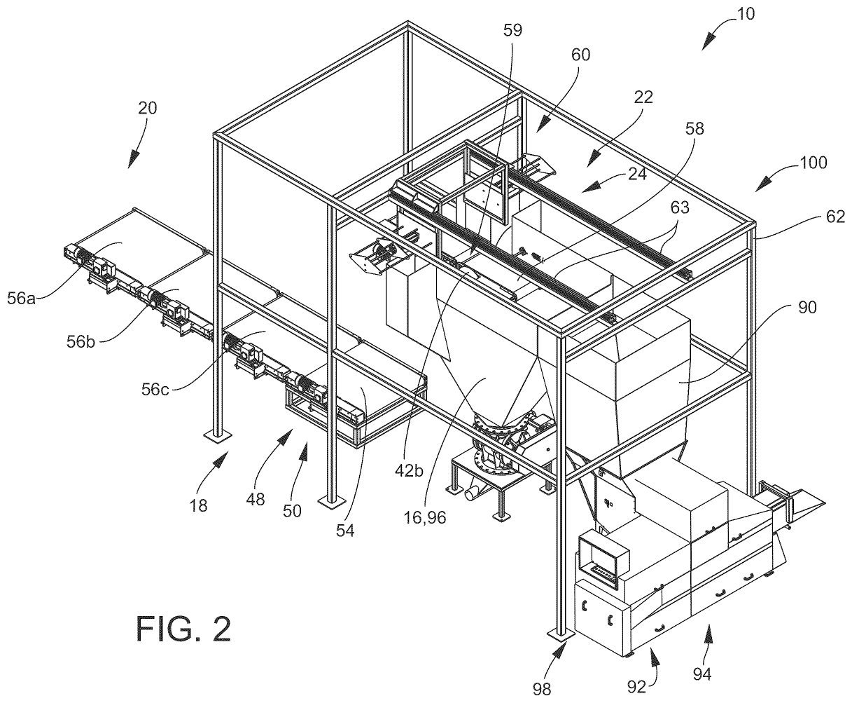

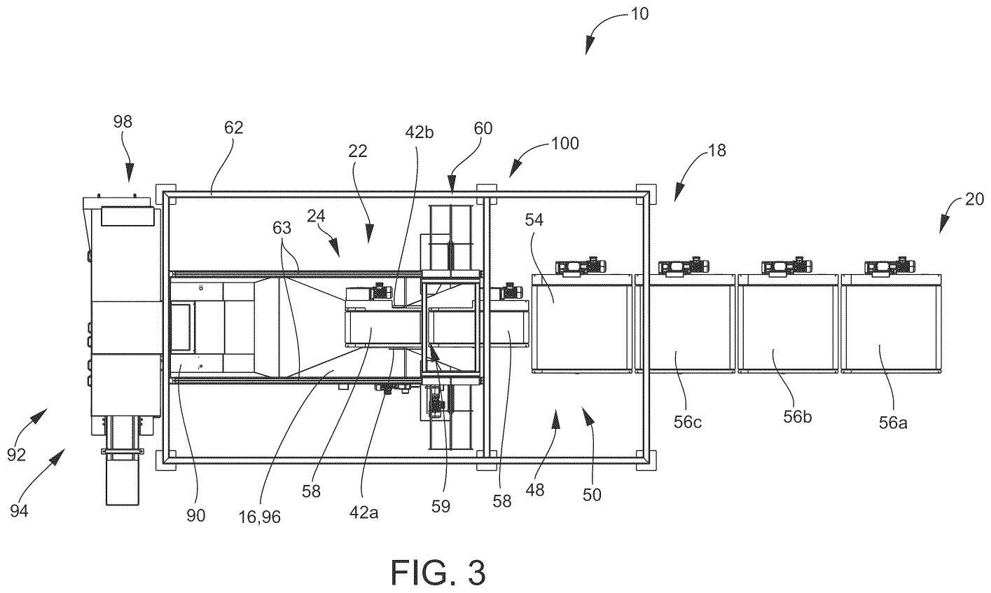

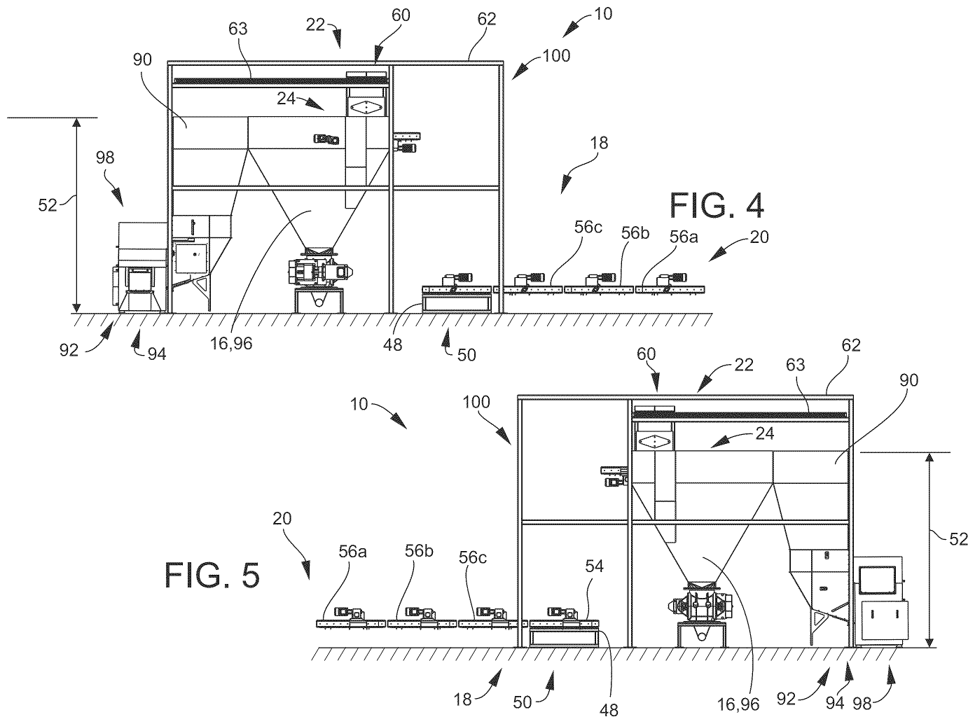

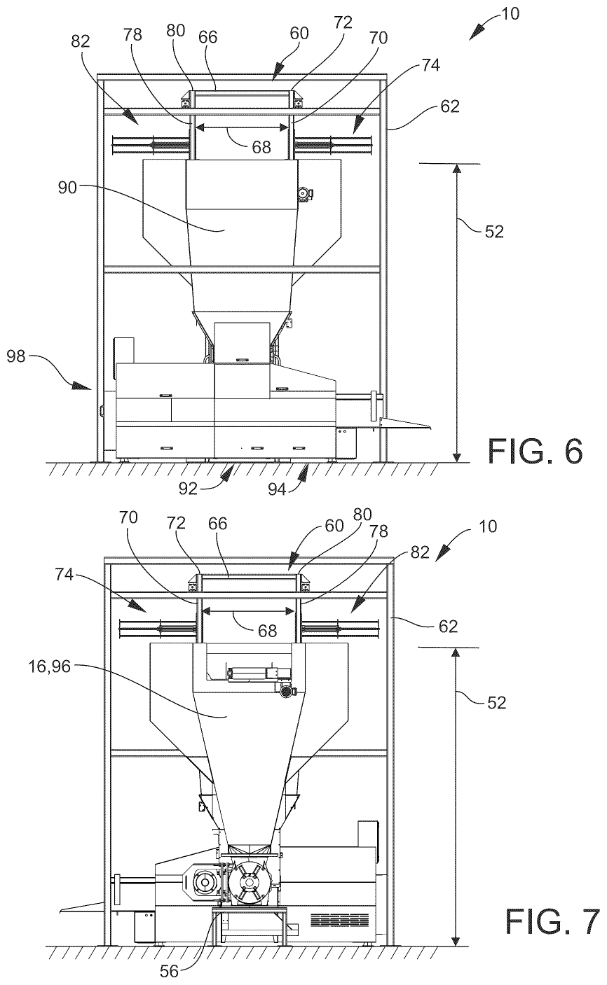

Referring now to FIGS. 1-23, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Certain terminology is used in the following description for convenience only and is not considered limiting. The words “right,” “left,” “lower” and “upper” designate directions in the drawings to which reference is made. This terminology includes the words specifically noted above, derivatives thereof and words of similar import. Additionally, the terms “a” and “one” are defined as including one or more of the referenced items unless specifically noted.

Referring first to FIGS. 1-7, the present disclosure may solve the aforementioned limitations of the currently available bulk bag unloading means and mechanisms, by providing the disclosed bulk back unloading assembly 10. Bulk bag unloading system 10 may be designed and configured for autonomously or automatically unloading bulk materials from bulk bag 14 with bulk materials 12 into hopper 16. Bulk bag unloading system 10 may generally include bag moving assembly 18 and automated cutting system 24. Bag moving assembly 18 may generally be for and configured to move bulk bag 14 filled with bulk materials 12 from loading location 20 to bag cutting area 22 above hopper 16. Automated cutting system 24 may generally be for and configured to automatically cut open bottom 28 of bulk bag 14 while in position over hopper 16 in bag cutting area 22. As such, automated cutting system 24 may be positioned over hopper 16 in bag cutting area 22. Automated cutting system 24 may include at least one motor driven or automated cutting device 26 configured to cut open bottom 28 of bulk bag 14 filled with bulk materials 12 while in position over hopper 16 in bag cutting area 22. Wherein, when bag moving assembly 18 moves bulk bag 14 filled with bulk materials 12 from loading location 20 to bag cutting area 22 over hopper 16, and automated cutting system 24 cuts open bottom 28 of bulk bag 14 while in position over hopper 16, bulk materials 12 from bulk bag 14 may discharge out of bottom 28 of bulk bag 14 and drop into hopper 16. Bulk bag unloading system 10 as designed and configured may allow for complete discharge or emptying of bulk material 12 from bulk bag 14.

One feature of automated bulk bag unloading system 10 may be that it can be configured to eliminate all operator interface in emptying bulk bag 14, or discharging bulk material 12 out of bulk bag 14 into hopper 16. As, such, automated bulk bag unloading system 10 may be configured to reduce or eliminate risk to operators unloading bulk bag 14, and/or for reducing or eliminating contamination of bulk material 12 as it is discharged out of bottom 28 of bulk bag 14 into hopper 16. In other words, automated bulk bag unloading system 10 may be designed and configured for “Hands free” or “Operator free” operation from the time bulk bag 14 is set onto infeed conveyor 56 at loading location 20 and/or bag lifting conveyor 54 (when no infeed conveyors 56 are used).

Another feature of automated bulk bag unloading system 10 may be that it can provide for more efficient unloading or discharging of bulk material 12 from bulk bag 14. In select embodiments, automated bulk bag unloading system 10 may be configured to allow for discharging of more than 10 bulk bags 14 per hour. In select possibly preferred embodiments, automated bulk bag unloading system 10 may be configured to allow for discharging of more than 25 of bulk bags 14 per hour. In select possibly most preferred embodiments, automated bulk bag unloading system 10 may be configured to allow for discharging of between 25 and 60 of bulk bags 14 per hour.

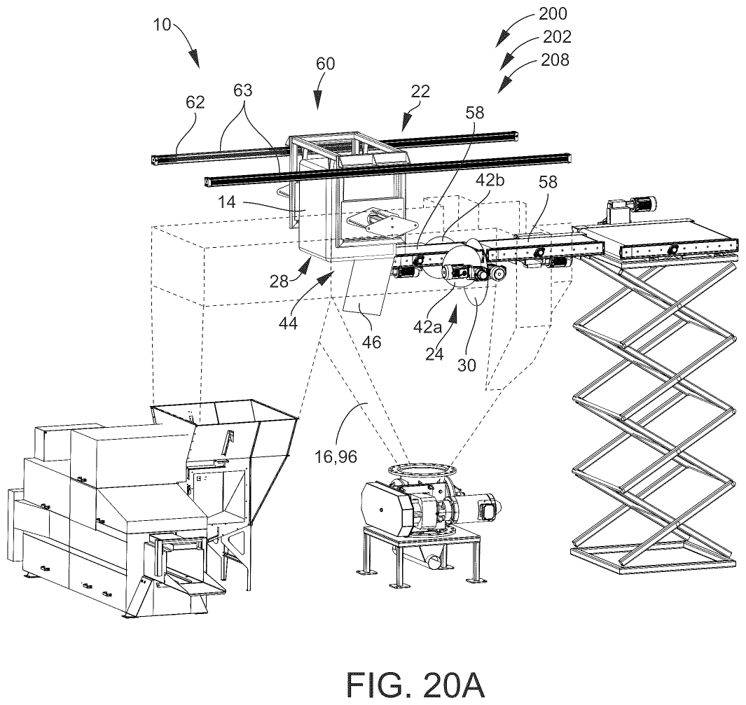

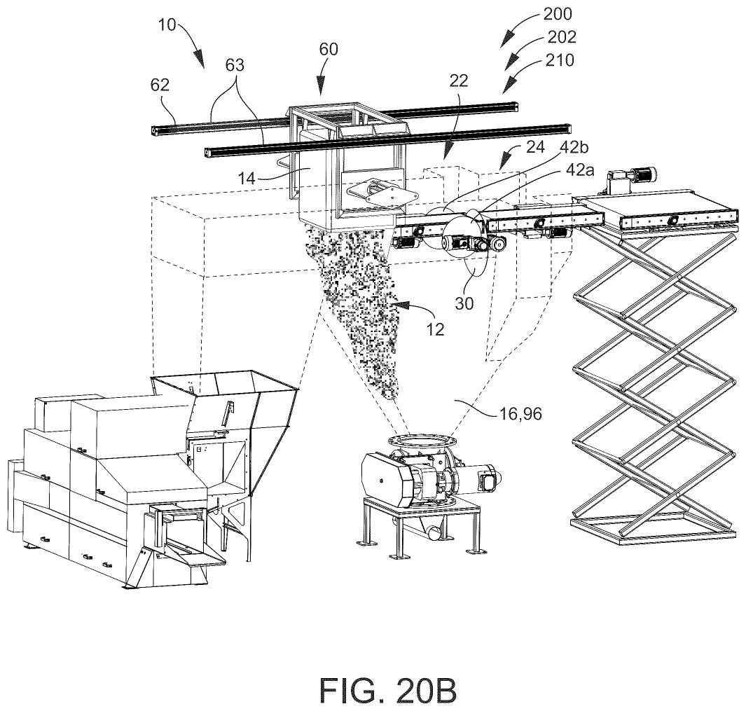

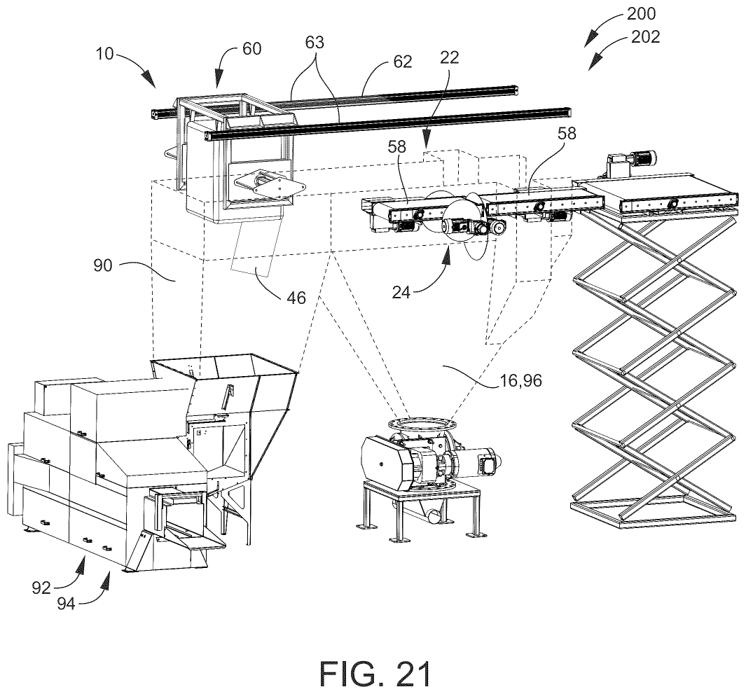

Automated cutting system 24 may generally be for and configured to automatically cut open bottom 28 of bulk bag 14 while in position over hopper 16 in bag cutting area 22. Automated cutting system 24 may be designed and configured with any type of knives, blades, saws, cutting mechanisms, the like, etc., designed and configured for automatically cutting open bottom 28 of bulk bag 14 while in position over hopper 16 in bag cutting area 22. As shown in the Figures, and clearly not limited thereto, in select embodiments of automated bulk bag unloading system 10, automated cutting system 24 may include linear rotating blade 30 and two stationary rotating blades 42 (first stationary rotating blade 42a and second stationary rotating blade 42b). Linear rotating blade 30 may be configured to cut bottom 28 of bulk bag 14 approximate front edge 32 of bulk bag 14 from approximate first side edge 34 of bottom 28 of bulk bag 14 to approximate second side edge 36 of bottom 28 of bulk bag 14. Linear rotating blade 30 may be mounted on linear shaft 38 with drive unit 40 configured to move linear rotating blade 30 from one side (first side 76) of bulk bag 14 to the other side (second side 84) of bulk bag 14 when set in position by bag moving assembly 18. The two stationary rotating blades 42 may be configured to cut bottom 28 of bulk bag 14 while bottom 28 of bulk bag 14 is moved over the two stationary rotating blades 42. In select embodiments, the two stationary rotating blades 42 may be parallel to one another. In select embodiments, the two stationary rotating blades 42 may include first stationary rotating blade 42a and second stationary rotating blade 42b. First stationary rotating blade 42a may be configured to cut bottom 28 of bulk bag 14 approximate to first side edge 34. Second stationary rotating blade 42b may be configured to cut bottom 28 of bulk bag 14 approximate to second side edge 36. In select embodiments, as shown in the Figures, and clearly not limited thereto, first stationary rotating blade 42a may be parallel to second stationary rotating blade 42b. Wherein, with the use of linear rotating blade 30 and the two stationary rotating blades 42 (first stationary rotating blade 42a and second stationary rotating blade 42b), automated cutting system 24 may be configured to automatically cut three sides 44 of bottom 28 of bulk bag 14 thereby creating openable flap portion 46 (see FIGS. 20A and 21) of bottom 28 of bulk bag 14. However, the disclosure is not so limited, and automated cutting system 24 of the disclosed automated bulk bag unloading system 10 can use other various cutting devices or patterns., The term bag cutting area 22, as used herein, may refer to any type or driven blade (where motion is imparted) in which the cutting blade is rotated. Each blade cutting assembly can be stationary or moved in a linear action while rotating. In another aspect, the rotating blades can be stationary. In another aspect, the rotating blade assemblies can move in various patterns, including linear in a parallel (as shown herein), perpendicular, or in an X-pattern for providing various cuts on bottom 28 or sides or top of bulk bag 14. One skilled in the art would understand that any other application of a stationary positioned, or movable rotating blade can be applied. The rotating blade assemblies are interchangeably referred to as cutting blade assemblies herein. In select embodiments, the linear rotating blade 30 and/or the two stationary rotating blades 42, or any other blades or cutting devices used in automated cutting system 24 may be non-serrated blades. The non-serrated blade feature of the disclosed automated cutting system 24 may be designed and configured to minimize debris from bulk bag 14 from entering hopper 16 from cutting open bottom 28 of bulk bag 14. In select embodiments, another feature of automated cutting system 24 may be the inclusion of a blade auto-sharpening assembly. The blade auto-sharpening assembly may be designed and configured to sharpen blades without manual/operator assistance, like for sharpening linear rotating blade 30 and/or two stationary rotating blades 42 without manual/operator assistance. In other select embodiments, as shown in the Figures, at least one or all of the blades of automated cutting system 24 may include a two-piece assembly. This two-piece assembly of the blade(s) of automated cutting system 24 may be designed and configured to allow for blade replacement without removal of shafts and/or bearings.

Bag moving assembly 18 may generally be for and configured to move bulk bag 14 filled with bulk materials 12 from loading location 20 to bag cutting area 22 above hopper 16. Bag moving assembly 18 may be designed and configured with any type of conveyors, lifts, bag stabilizer, the like, etc., designed and configured for automatically moving bulk bag 14 filled with bulk materials 12 from loading location 20 to bag cutting area 22. As shown in the Figures, and clearly not limited thereto, in select embodiments of automated bulk bag unloading system 10, bag moving assembly 18 may include bag lifting device 48 at lifting location 50. However, the disclosure is not so limited, and bag lifting device 48 may not be required if loading location 20 is positioned at the same height 52 of bag cutting area 22 (like a second story loading area). Bag lifting device 48 may be configured to elevate bulk bag 14 to height 52 of bag cutting area 22 over hopper 16. In select embodiments, as shown in the Figures, bag lifting device 48 may include bag lifting conveyor 54 configured to move bulk bag 14 filled with bulk materials 12 onto and off bag lifting device 48.

In select embodiments of automated bulk bag unloading system 10, bag moving assembly 18 may include at least one infeed conveyor 56. The at least one infeed conveyor 56 may be configured to introduce bulk bag 14 filled with bulk materials 12 from loading location 20 onto bag lifting conveyor 54 on bag lifting device 48 at lifting location 50, or directly to bag cutting area 22 if bag lifting device 48 is not required. Bag moving assembly 18 may include any number of infeed conveyors 56, including multiple (like 20 or more) infeed conveyors 56 in line configured to introduce bulk bag 14 filled with bulk material 12 from loading location 20 onto bag lifting conveyor 54 on bag lifting device 48 at lifting location 50 (if required). In select embodiments, as shown in the Figures, and clearly not limited thereto, bag moving assembly 18 may include three infeed conveyors 56 (first infeed conveyor 56a, second infeed conveyor 56b, and third infeed conveyor 56c) in line configured to introduce bulk bag 14 filled with bulk materials 12 from loading location 20 onto bag lifting conveyor 54 on bag lifting device 48 at lifting location 50. Infeed conveyor 56, or any number of plurality of infeed conveyors 56, may be designed and configured with any shape, size, length or number, configured for introducing bulk bag 14 filled with bulk materials 12 from loading location 20 onto bag lifting conveyor 54 on bag lifting device 48 at lifting location 50, or directly to bag cutting area 22 if bag lifting device 48 is not required.

In select embodiments of automated bulk bag unloading system 10, bag moving assembly 18 may include automatic hopper transfer conveyor 58 positioned in bag cutting area 22 over the hopper. Automatic hopper transfer conveyor 58 may be configured to transfer bulk bag 14 filled with bulk materials 12 from bag lifting device 48 through bag cutting area 22 over hopper 16 for cutting open bottom 28 of bulk bag 14 with the cutting devices or blades of automated cutting system 24. Automatic hopper transfer conveyor 58 may be designed and configured to move bulk bag 14 at the proper movements required for any cutting devices or blades of automated cutting system 24. In select embodiments, as shown in the Figures, automatic hopper transfer conveyor 58 may include gap 59. Gap 59 may be configured to allow linear (transverse direction) rotating blade 30 to traverse through automatic hopper transfer conveyor 58 for cutting bottom 28 of bulk bag 14 while positioned on automatic hopper transfer conveyor 58 in bag cutting area 22 over hopper 16. In select embodiments, automatic hopper transfer conveyor 58 may include at least a portion sized and positioned between two stationary rotating blades 42 configured to cut bottom 28 of bulk bag 14 while bottom 28 of bulk bag 14 is moved over the two stationary rotating blades 42 via automatic hopper transfer conveyor 58 and simultaneously being supported and moved by bag stabilizer device 60.

Another feature of automated bulk bag unloading system 10 may be that bag moving assembly 18 can include bag stabilizer device 60. Bag stabilizer device 60 may be configured to secure and move bulk bag 14 through bag cutting area 22 over hopper 16 while bottom 28 of bulk bag 14 is being cut open by automated cutting system 24 and when bulk materials 12 are discharging out of bottom 28 of bulk bag 14 and into hopper 16. Bag stabilizer device 60, may be any device or mechanism configured to secure and move bulk bag 14 through bag cutting area 22 over hopper 16 while bottom 28 of bulk bag 14 is being cut open by automated cutting system 24 and when bulk materials 12 are discharging out of bottom 28 of bulk bag 14 and into hopper 16. In select embodiments of automated bulk bag unloading system 10, frame 62 may be included. Frame 62 may be configured to support bag stabilizer device 60 while securing and moving bulk bag 14 through bag cutting area 22 over hopper 16. In select embodiments, frame 62 may include two linear rails 63. Two linear rails 63 may be attached to or integrally formed with frame 62. Two linear rails 63 may be configured for supporting bag stabilizer device 60 with bulk bag 14 filled with bulk material 12 over the hopper 16 while moving linearly through bag cutting area 22 while bottom 28 of bulk bag 14 is being cut open by automated cutting system 24 and when bulk materials 12 are discharging out of bottom 28 of bulk bag 14 and into hopper 16.

Another feature of automated bulk bag unloading system 10 automatic hopper transfer conveyor 58 and bag stabilizer device 60 may be synchronized together for moving bulk bag 14 through bag cutting area 22 over hopper 16 at the same pace and movement 64, and for moving the cut open bulk bag 14 off of automatic hopper transfer conveyor 58 for discharging bulk materials 12 from bulk bag 14 into hopper 16. In select embodiments, as shown in the Figures, and clearly not limited thereto, bag stabilizer device 60 may include top member 66, first side bracket 70 and second side bracket 78. Top member 66 may have width 68 sized wider than bulk bag 14. First side bracket 70 may extend down from top member 66 on first end 72 of top member 66. First side bracket 70 may include at least one first side puncturing rod 74. Each of the at least one first side puncturing rod 74 may be configured to move into and out of first side bracket 70 of bag stabilizer device 60 for puncturing and securing first side 76 of bulk bag 14. Wherein, when each of the at least one first side puncturing rod 74 is moved into bag stabilizer device 60, each of the at least one first side puncturing rod 74 may be configured to puncture first side 76 of bulk bag 14 for securing and holding first side 76 of bulk bag 14 while moving through bag cutting area 22 over hopper 16. Second side bracket 78 may extend down from top member 66 on second end 80 of top member 66. Second side bracket 78 may include at least one second side puncturing rod 82. Each of the at least one second side puncturing rod 82 may be configured to move into and back out of second side bracket 78 of bulk bag stabilizer device 60 for puncturing and securing second side 84 of bulk bag 14. Wherein, when each of the at least one second side puncturing rod 82 is moved into bag stabilizer device 60, each of the at least one second side puncturing rod 82 may be configured to puncture second side 84 of bulk bag 14 for securing and holding second side 84 of bulk bag 14 while moving through bag cutting area 22 over hopper 16. In select embodiments, as shown in the Figures, and clearly not limited thereto, first side bracket 70 of bag stabilizer device 60 may include multiple, including four, first side puncturing rods 74 in horizontal diamond shape configuration 86. Horizontal diamond shape configuration 86 of first side puncturing rods 74 may be designed and configured to stabilize first side 76 of bulk bag 14 within bag stabilizer device 60. In other select embodiments, each of the first side puncturing rods 74 may include pointed tips 88. Pointed tips 88 may be designed and configured to puncture bulk bag 14 without ripping, tearing, or causing excess shrapnel or debris from bulk bag 14 when being punctured by each of the first side puncturing rods 74. In other select embodiments, second side bracket 78 of bag stabilizer device 60 may include multiple, including four, second side puncturing rods 82 in the similar horizontal diamond shape configuration 86. Horizontal diamond shape configuration 86 of second side puncturing rods 82 may be designed and configured to stabilize second side 84 of bulk bag 14 within bag stabilizer device 60. In other select embodiments, each of the second side puncturing rods 82 may include pointed tips 88. Pointed tips 88 may be designed and configured to puncture bulk bag 14 without ripping, tearing, or causing excess shrapnel or debris from bulk bag 14 when being punctured by each of the second side puncturing rods 82.

Another feature of automatic bulk bag unloader system 10 may be that when automated cutting system 24 cuts open bottom 28 of bulk bag 14 while in position over hopper 16 and bulk materials 12 from bulk bag 14 automatically empty or discharge into hopper 16 through the cut open bottom 28 of bulk bag 14, bag stabilizer device 60 may be configured to move the emptied bulk bag 14 out away from over the top of hopper 16. In select embodiments, when bag stabilizer device 60 moves the emptied bulk bag 14 out away from over hopper 16, bag stabilizer device 60 may be configured to drop the emptied bulk bag 14 by moving each of the at least one first side puncturing rods 74 from first side 76 of bulk bag 14 and moving each of the at least one second side puncturing rods 82 from second side 84 of bulk bag 14.

In select embodiments of automatic bulk bag unloader system 10, bag waste container 90 may also be included. Bag waste container 90 may be anything for collecting and disposing or recycling the emptied bulk bag 14. In select embodiments, bag waste container 90 may be a waste bin, baler 92, compactor 94, and/or the like. Wherein, when bag stabilizer device 60 may move the emptied bulk bag 14 out from over hopper 16, bag stabilizer device 60 may be designed and configured to move emptied bulk bag 14 over bag waste container 90 and to drop the emptied bulk bag 14 into bag waste container 90, like for disposing, baling or compacting the emptied bulk bag 14. As such, with the use of bag waste container 90 with baler 92 and/or compactor 94, bulk bag unloader system 10 may be designed and configured to minimize the waste stream of bulk bags 14.

In select embodiments of automated bulk bag unloading system 10, as shown in the Figures, hopper 16 may include or be surge hopper 96. As shown in the Figures, surge hopper 96 may include automated cutting system 24 integrally coupled, attached, or formed therein. Wherein, automated cutting system 24 may be configured to cut bottom 28 of bulk bag 14 allowing bulk material 12 to discharge directly into surge hopper 96. Wherein, surge hopper 96 may be configured to store the contents and discharge bulk material product 12 through downstream metering equipment to meet process requirements.

Another feature of automated bulk bag unloading system 10 may be that it can be controlled via control system 98. Control system 98 may be configured to control the entire automated bulk bag unloading system 10, including, but not limited to, safety inputs, conveyors, lifts, the bag stabilizer device, the driven cutting blade(s), etc. Control system 98 may be configured to control automated cutting system 24 and the at least one motor driven or automated cutting device 26 of the automated cutting system 24 to ensure bottom 28 of bulk bag 14 is opened allowing for discharge of bulk material 12 from bottom 28 of bulk bag 14. Control system 98 may also control the movements of bag moving assembly 18. As such, control system 98 may be designed and configured to synchronize the movements of bag moving assembly 18 with automated cutting system 24 for discharging bulk material 12 out of bottom 28 of bulk bag 14 into hopper 16.

In select embodiments of automated bulk bag unloading system 10, the entire automated bulk bag unloading system 10 may be fully enclosed for operator safety and/or dust control.

In select embodiments of automated bulk bag unloading system 10, the automated bulk bag unloading system 10 may further include dust collection assembly 100. Dust collection assembly 100 may be configured for collecting dust or loose materials from in and around the bulk bag 14 and bag cutting area 22 before and while being emptied into hopper 16.

In another aspect, the instant disclosure embraces automated bulk bag unloading system 10 in any embodiments and/or combination of embodiments shown and/or described herein.

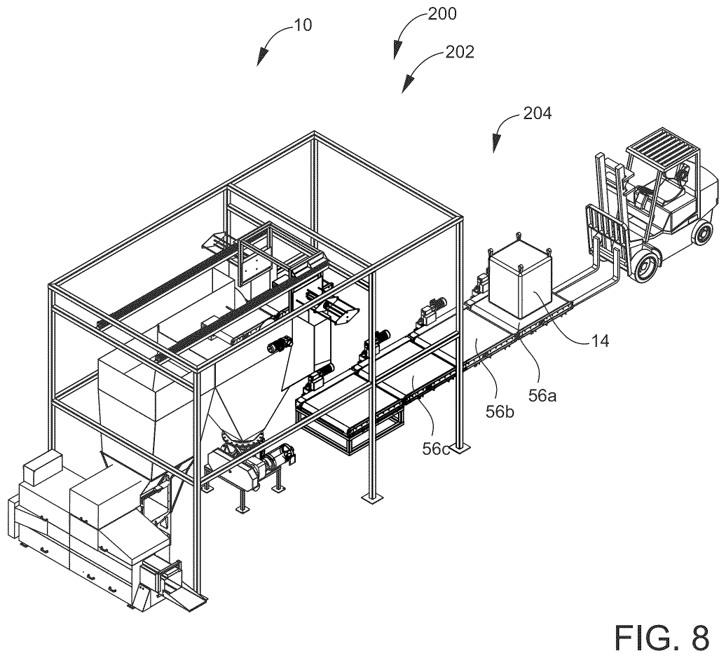

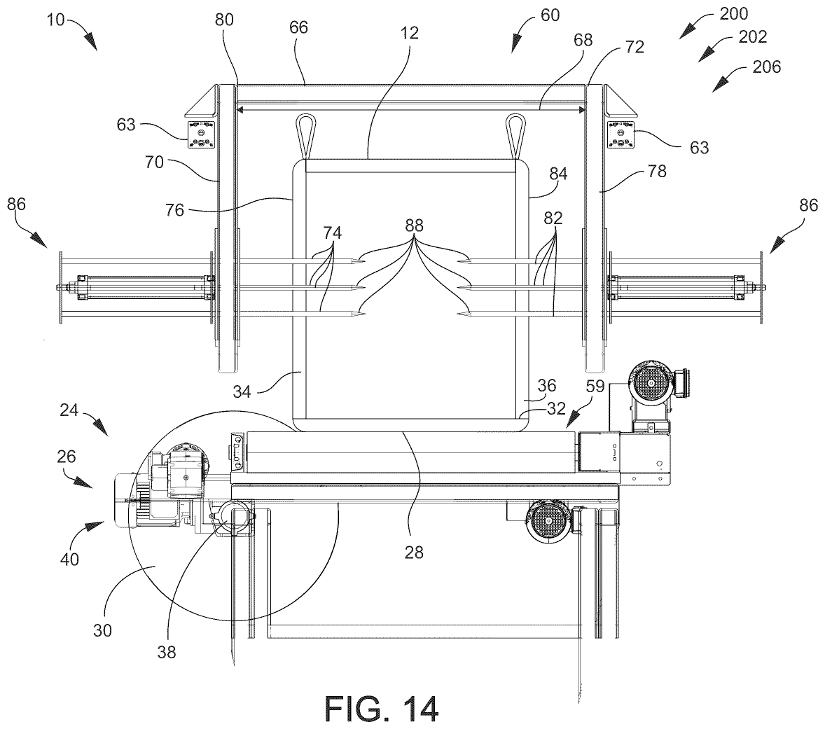

Referring now to FIGS. 8-23, in another aspect, the instant disclosure embraces method 200 of automatically discharging bulk bag 14 filled with bulk materials 12. Method 200 of automatically discharging bulk bag 14 filled with bulk materials 12 may generally include utilizing the disclosed automated bulk bag unloading system 10 in any embodiments and/or combination of embodiments shown and/or described herein. As such, method 200 of automatically discharging bulk bag 14 filled with bulk materials 12 may generally include step 202 of providing automated bulk bag unloading system 10 (see FIGS. 8-23) for autonomously unloading bulk materials 12 from bulk bag 14 into hopper 16, where automated bulk bag unloading system 10 may generally include bag moving assembly 18 and automated cutting system 24. Bag moving assembly 18 may be configured to move bulk bag 14 filled with bulk materials 12 from loading location 20 to bag cutting area 22 above hopper 16. Automated cutting system 24 may be positioned over hopper 16 in bag cutting area 22. Automated cutting system 24 may include at least one motor driven or automated cutting device 26 configured to automatically cut open bottom 28 of bulk bag 14 filled with bulk materials 12 while in position over hopper 16. Wherein, with the provided automated bulk bag unloading system 10, method 200 of automatically discharging bulk bag 14 filled with bulk materials 12 may further include: step 204 of moving bulk bag 14 filled with bulk materials 12 from loading location 20 to bag cutting area 22 over hopper 16 via bag moving assembly 18 (see FIGS. 8-13); step 206 of cutting open bottom 28 of bulk bag 14 while in position over hopper 16 via automated cutting system 24 (see FIGS. 14-219); step 208 of discharging the bulk materials 12 out of the cut open bottom 28 of bulk bag 14 (see FIG. 20A); and step 210 of dropping the bulk materials 12 from the cut open bottom 28 of bulk bag 14 into hopper 1.

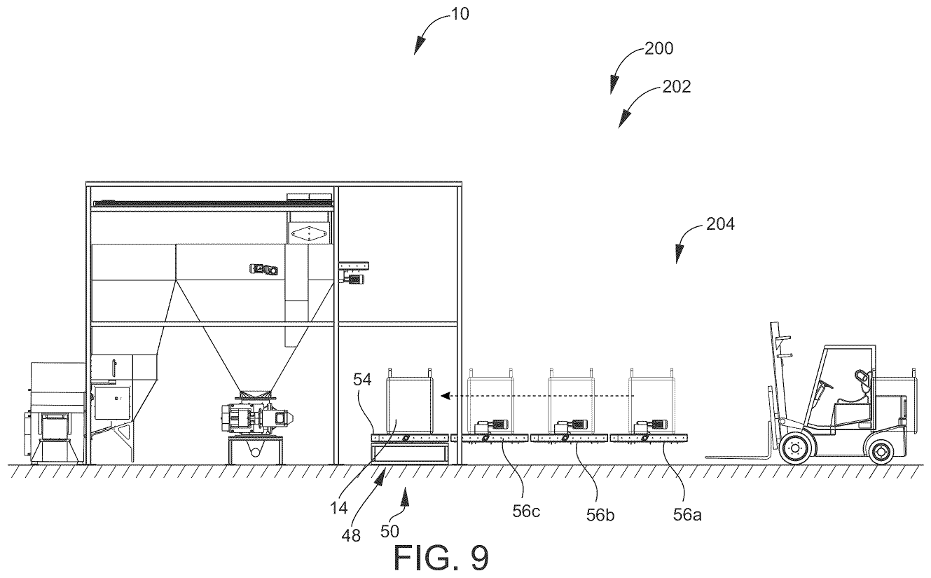

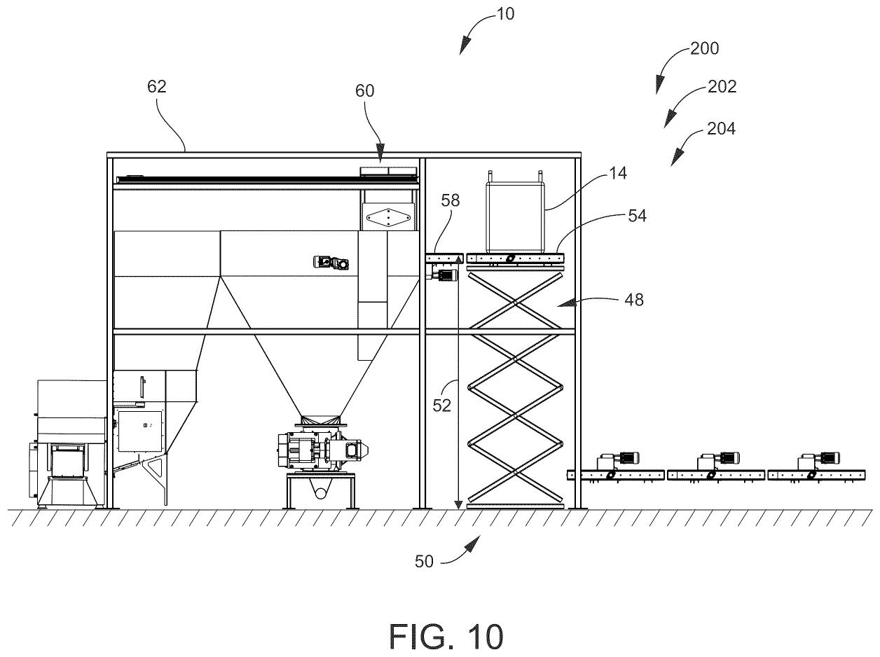

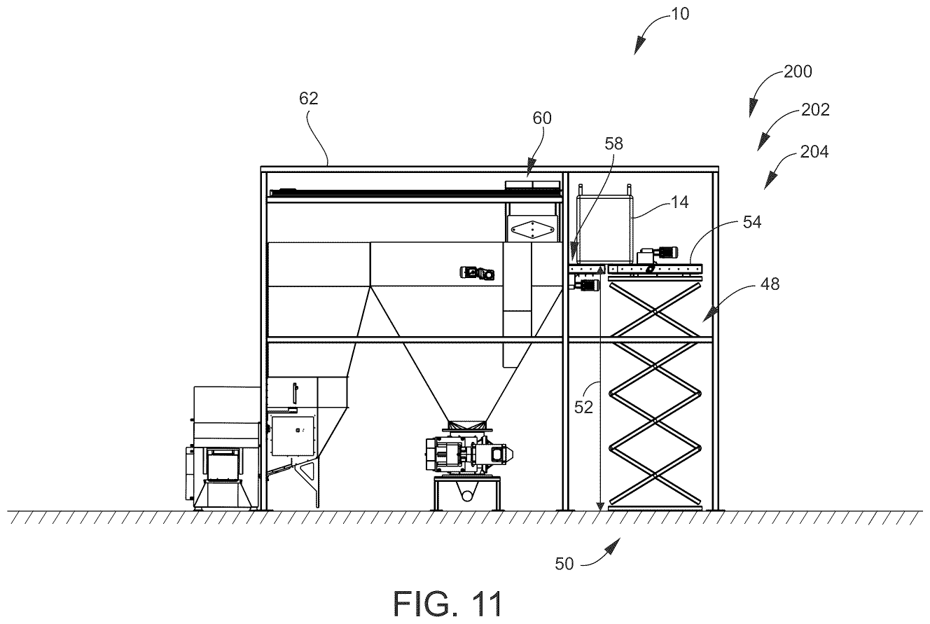

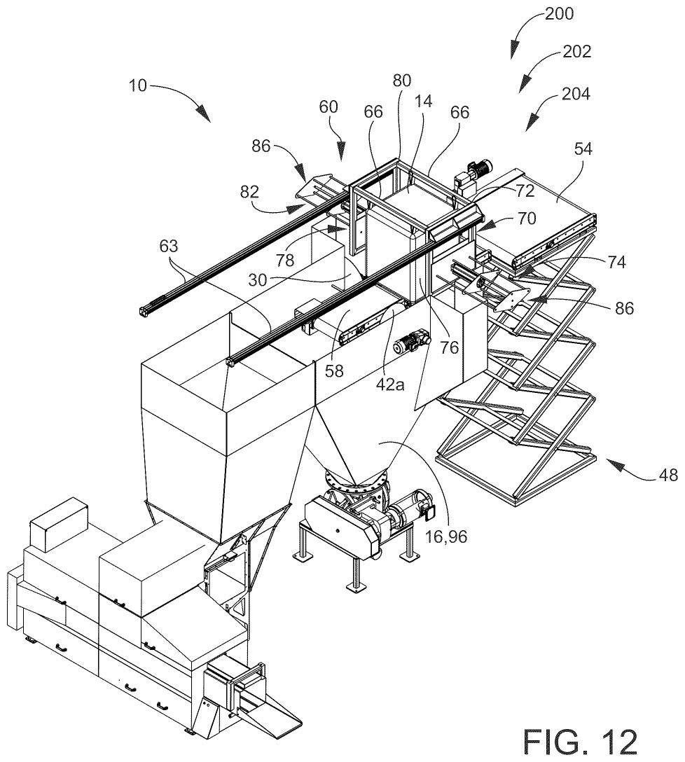

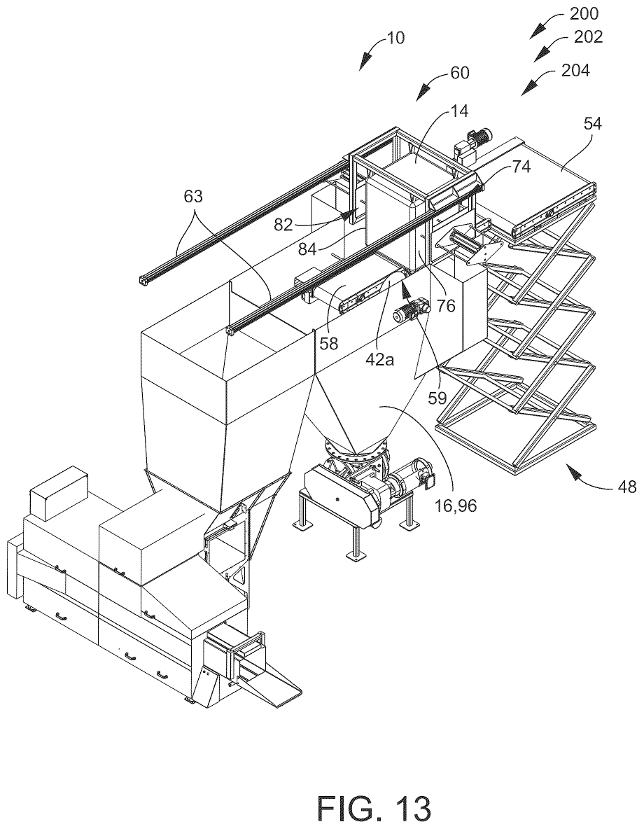

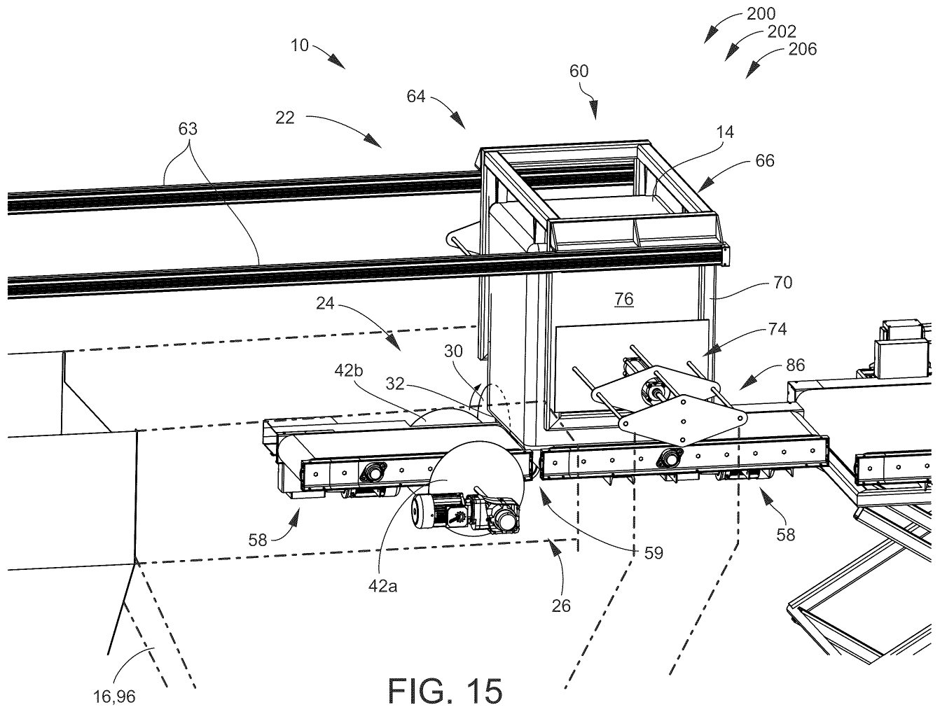

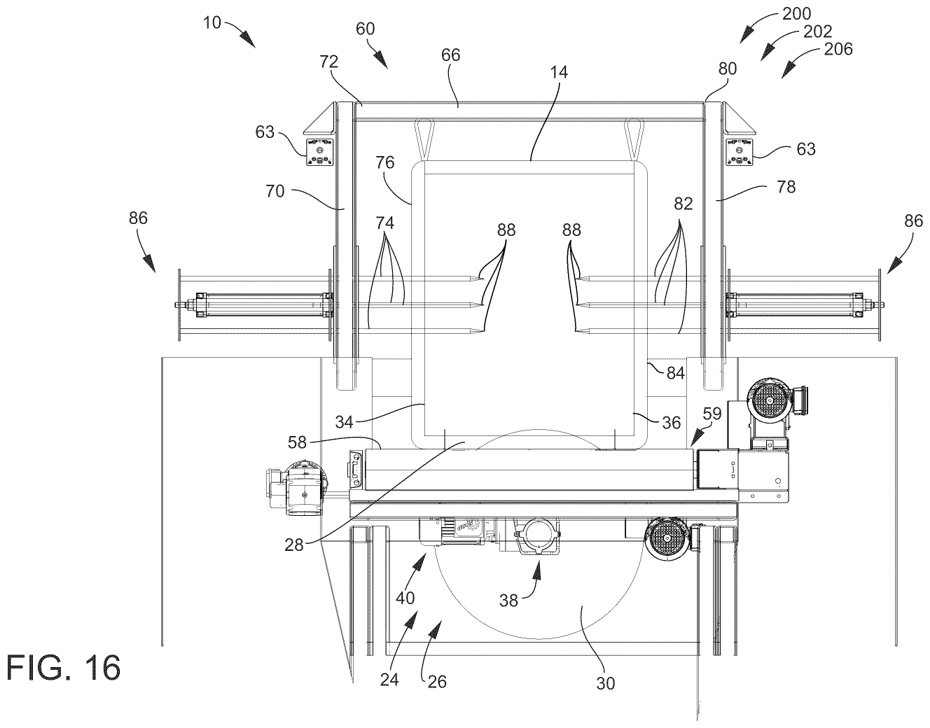

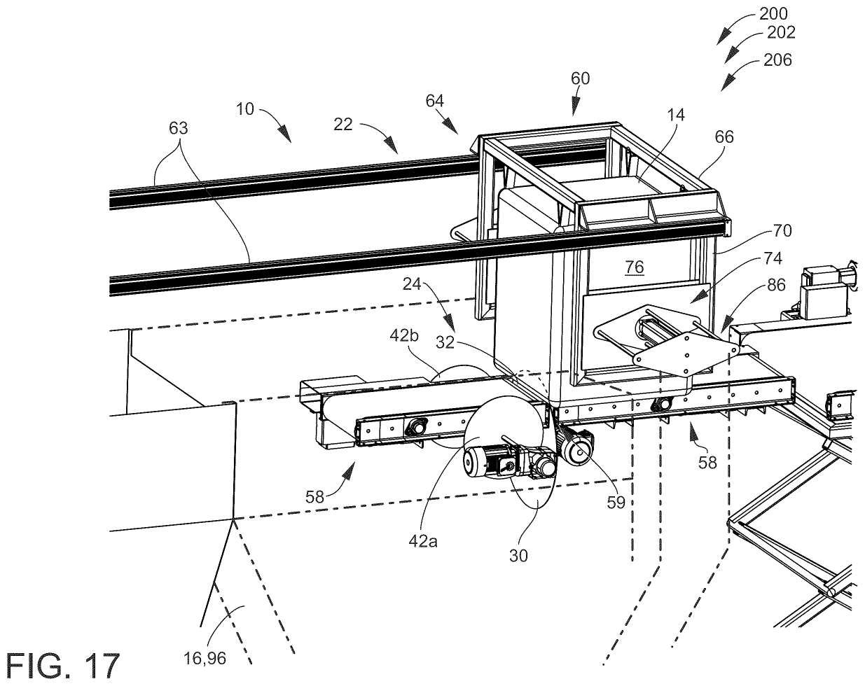

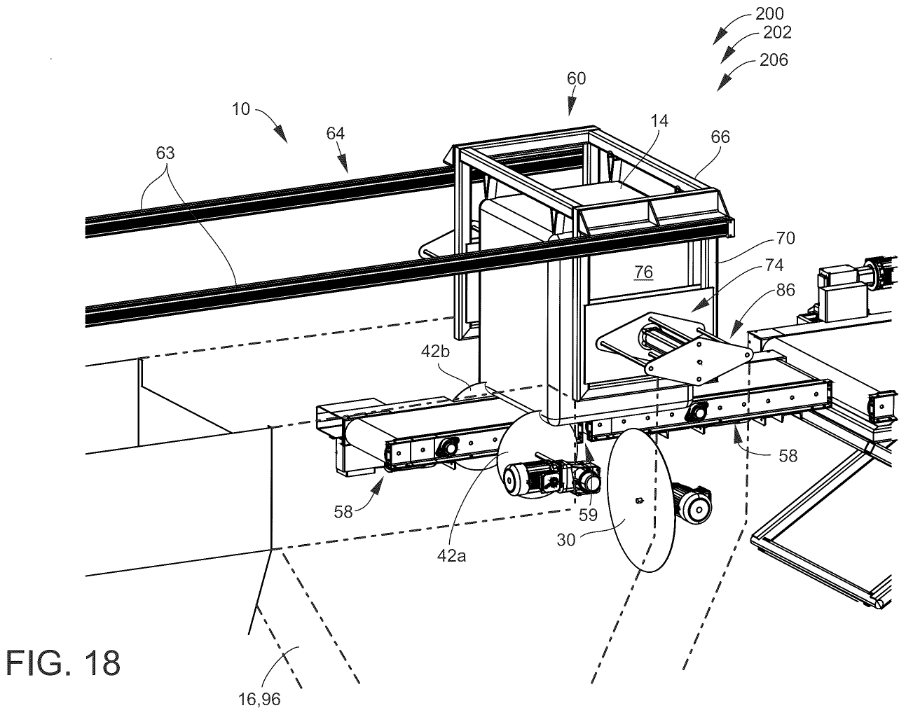

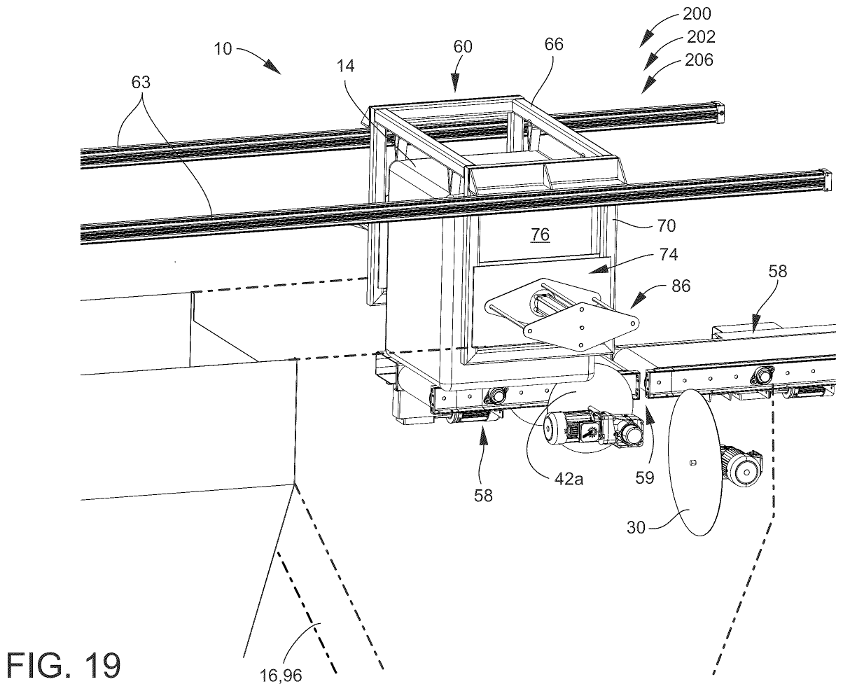

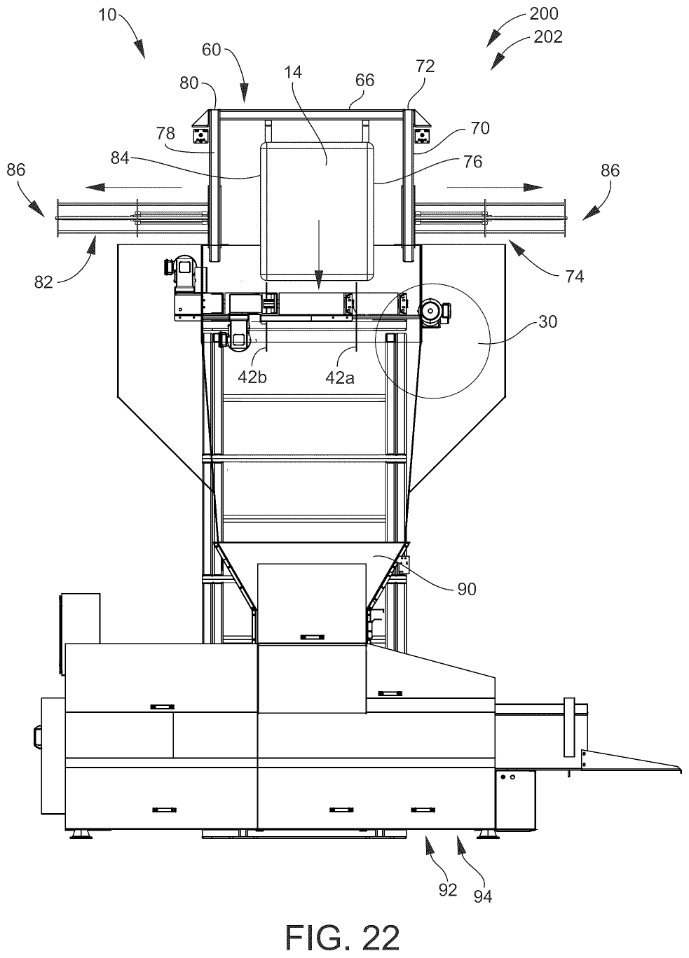

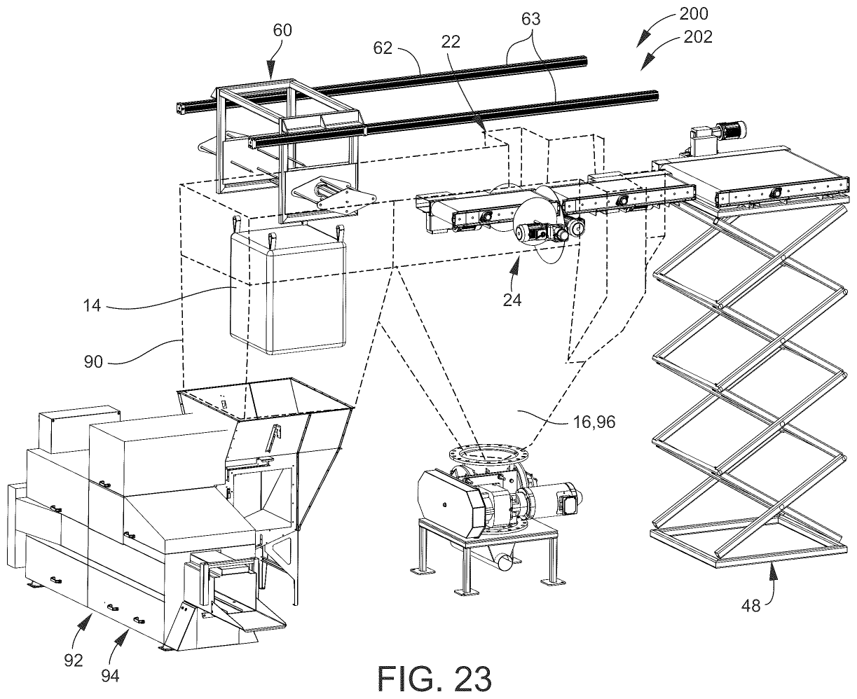

Referring still to FIGS. 8-23, the disclosed automated bulk bag unloading system 10 is shown in possibly typical chronological use to provide the disclosed method 200 of automatically discharging of bulk materials 12 from bulk bag 14. FIG. 8 shows automated bulk bag unloading system 10 with a fork lift machine loading bulk bag 14 onto infeed conveyors 56 of bag moving assembly 18 at loading location 20, namely onto first infeed conveyor 56a for transfer to second infeed conveyor 56b and so forth. FIG. 9 shows automated bulk bag unloading system 10 with bulk bag 14 moving from infeed conveyors 56 to lifting conveyor 54 on lifting device 48 at lifting location 50. FIG. 10 shows automated bulk bag unloading system 10 with bulk bag 14 lifted to height 52 of bag cutting area 22 over hopper 16 via lifting device 48. FIG. 11 shows automated bulk bag unloading system 10 with bulk bag 14 moving from lifting conveyor 54 to automatic hopper transfer conveyor 58 in bag cutting area 22 over hopper 16. FIG. 12 shows automated bulk bag unloading system 10 with frame 62 removed showing bulk bag 14 in position on automatic hopper transfer conveyor 58 for bag stabilizer device 60 to secure bulk bag 14 on automatic hopper transfer conveyor 58. FIG. 13 shows automated bulk bag unloading system 10 with frame 62 removed showing bag stabilizer device 60 securing bulk bag 14 on automatic hopper transfer conveyor 58 by puncturing the sides (first side 76 and second side 84) of bulk bag 14 with the first and second side puncturing rods 74 and 82, respectively. FIG. 14 shows automated bulk bag unloading system 10 with bag stabilizer device 60 securing bulk bag 14 on automatic hopper transfer conveyor 58 by puncturing sides (first side 76 and second side 84) of bulk bag 14 with the first and second side puncturing rods 74 and 82, respectively, and also shows the linear (transverse direction) rotating blade 30 in position on the side (first side 76) of bulk bag 14. FIG. 15 shows automated bulk bag unloading system 10 with frame 62 removed showing bulk bag 14 on automatic hopper transfer conveyor 58 and secured by bag stabilizer device 60 and in position for the linear (transverse direction) rotating blade 30 to make a cut along the transverse direction of the leading or front edge 32 of bottom 28 of bulk bag 14. FIG. 16 shows automated bulk bag unloading system 10 showing bulk bag 14 on automatic hopper transfer conveyor 58 and secured by bag stabilizer device 60 with the linear (transverse direction) rotating blade 30 making the cut through gap 59 along the transverse direction of the leading or front edge 32 of bottom 28 of bulk bag 14. FIG. 17 shows automated bulk bag unloading system 10 with frame 62 removed showing bulk bag 14 on automatic hopper transfer conveyor 58 and secured by bag stabilizer device 60 with linear (transverse direction) rotating blade 30 making the cut through gap 59 along the transverse direction of the leading or front edge 32 of bottom 28 of bulk bag 14. FIG. 18 shows automated bulk bag unloading system 10 with frame 62 removed showing bulk bag 14 on automatic hopper transfer conveyor 58 after being cut by the linear (transverse direction) rotating blade 30 on leading or front edge 32 of bottom 28 of bulk bag 14 moving further along automatic hopper transfer conveyor 58 with the two stationary (machine direction) rotating blades 42 (first stationary rotating blade 42a and second stationary rotating blade 42b) making cuts along the machine direction of approximately both side edges (first side edge 34 and second side edge 36, respectively) of bottom 28 of bulk bag 14. FIG. 19 shows bulk bag unloading system 10 with the frame 62 removed showing bulk bag 14 on automatic hopper transfer conveyor 58 moving further along automatic hopper transfer conveyor 58 with the two stationary (machine direction) rotating blades 42 (first stationary rotating blade 42a and second stationary rotating blade 42b) finishing the cuts along the machine direction of both side edges (first side edge 34 and second side edge 36, respectively) of bottom 28 of bulk bag 14. FIG. 20A shows automated bulk bag unloading system 10 with frame 62 removed showing bulk bag 14 moving off of automatic hopper transfer conveyor 58 after being cut by the two stationary (machine direction) rotating blades 42 (first stationary rotating blade 42a and second stationary rotating blade 42b) along the machine direction of both side edges (first side edge 34 and second side edge 36, respectively) of bottom 28 of bulk bag 14, where bag stabilizer device 60 is securing and holding bulk bag 14 over hopper 16 and openable flap portion 46 of bottom 28 of bulk bag 14 is open. FIG. 20B shows automated bulk bag unloading system 10 with frame 62 removed showing bag stabilizer device 60 holding bulk bag 14 over hopper 16 and openable flap portion 46 of bottom of bulk bag 14 is opened and bulk materials 12 are discharging or falling out of bottom 28 of bulk bag 14 and into hopper 16. FIG. 20A of the opening of openable flap portion 46 and FIG. 20B of bulk materials 12 discharging or falling out of bottom 28 of bulk bag 14 and into hopper 16 happen almost simultaneously. FIG. 21 shows automated bulk bag unloading system 10 with frame 62 removed showing the emptied bulk bag 14 moved over bag waste container 9—via bag stabilizer device 60. FIG. 22 shows automated bulk bag unloading system 10 with frame 62 removed showing bulk bag 14 positioned over bag waste container 90 and bag stabilizer device 60 releasing bulk bag 14 by removing the first and second side puncturing rods 74 and 82, respectively, from the sides of bulk bag 14. FIG. 23 shows automated bulk bag unloading system 10 with frame 62 removed showing bulk bag 14 falling into bag waste container 90 after being released by bag stabilizer device 60.

In sum, automated bulk bag unloading system 10 with automated blade cutting system 24 is disclosed herein. The automated cutting assembly 24 includes at least one, preferably multiple, motor driven or automated cutting blades 26 as well as a bag moving assembly 18 that introduces bulk bag 14 filled with bulk material 12 to automated cutting system 24 and removes the empty bag when finished. Automated bulk bag unloading system 10 may include infeed conveyor(s) 56 to introduce bulk bags to the lift assembly. For example, in low-capacity units, this can be loaded with a fork truck or similar. Bag lifting device(s) 48 may be included (if necessary) to elevate bulk bag 14 from ground level to bag cutting area 22 over hopper 16. Bag lifting conveyor(s) 54 and automatic hopper transfer conveyor(s) 58 may introduce bulk bag 14 to bag stabilizer device 60. Bag stabilizer device 60 may secure and move bulk bag 14 through the automated blade cutting system 24 over hopper 16. Automated blade cutting system 24 may cut bottom 28 of bulk bag 14 allowing bulk material 12 to discharge directly into the integral cutting assembly surge hopper 96. Surge hopper 96 may store the contents and discharge bulk material product 12 through downstream metering equipment to meet process requirements. The entire assembly may be controlled via control system 98. Control system 98 may control the multiple driven blades 26 to ensure the (entire bottom) bag bottom 28 is opened allowing for quick (instantaneous) discharge. One linear rotating blade 30 and two parallel, stationary rotating blades 42 may be used to cut the bottom 28 of bulk bag 14, but multiple in-line or an X cutting pattern can be provided to meet this requirement. The entire automated bulk bag unloading system 10 may be enclosed for operator safety and/or dust control. For various products a dust collection assembly 100 may also be included with automated bulk bag unloading system 10. As a result, automated bulk bag unloading system 10 may eliminate all operator interface in emptying the bag and may allow for discharging of between 25-60 bags/hour.

In the specification and/or figures, typical embodiments of the disclosure have been disclosed. The present disclosure is not limited to such exemplary embodiments. The use of the term “and/or”includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. An automated bulk bag unloading system for autonomously unloading bulk materials from a bulk bag into a hopper, the automated bulk bag unloading system comprising:
a bag moving assembly configured to move the bulk bag filled with the bulk materials from a loading location to a bag cutting area above the hopper;
an automated cutting system positioned over the hopper in the bag cutting area, the automated cutting system including at least one automated cutting device configured to cut open a bottom of the bulk bag filled with the bulk materials while in position over the hopper; and
wherein, when the bag moving assembly moves the bulk bag filled with the bulk materials from the loading location to the bag cutting area over the hopper, and the automated cutting system cuts open the bottom of the bulk bag while in position over the hopper, the bulk materials from the bulk bag discharging out of the bottom of the bulk bag and drop into the hopper.

2. The automated bulk bag unloading system according to claim 1 being configured to eliminate all operator interface in emptying the bulk bag and allow for discharging of more than 10 bulk bags per hour.

3. The automated bulk bag unloading system according to claim 2 being configured to allow for discharging of more than 25 of the bulk bags per hour.

4. The automated bulk bag unloading system according to claim 3 being configured to allow for discharging of between 25 to 60 of the bulk bags per hour.

5. The automated bulk bag unloading system according to claim 1, wherein the automated cutting system including:
a linear rotating blade configured to cut the bottom of the bulk bag approximate a front edge of the bulk bag from approximate a first side edge of the bulk bag to approximate a second side edge of the bulk bag, the linear rotating blade is mounted on a linear shaft with a drive unit configured to move the linear rotating blade from one side of the bulk bag to the other side of the bulk bag;
two stationary rotating blades configured to cut the bottom of the bulk bag while the bottom of the bulk bag is moved over the two stationary rotating blades, the two stationary rotating blades are parallel, the two stationary rotating blades including:
a first stationary rotating blade configured to cut the bottom of the bulk bag approximate to the first side edge;
a second stationary rotating blade configured to cut the bottom of the bulk bag approximate to the second side edge;
the first stationary rotating blade is parallel with the second stationary rotating blade; and
wherein, the automated cutting system is configured to automatically cut three sides of the bottom of the bulk bag thereby creating an openable flap portion of the bottom of the bulk bag;
wherein, the linear rotating blade and the two stationary rotating blades are non-serrated blades configured to minimize debris from the bulk bag from entering the hopper.

6. The automated bulk bag unloading system according to claim 1, wherein the bag moving assembly including a bag lifting device at a lifting location, the bag lifting device is configured to elevate the bulk bag to a height of the bag cutting area over the hopper; and
wherein the bag lifting device including a bag lifting conveyor configured to move the bulk bag filled with the bulk materials onto and off the bag lifting device.

7. The automated bulk bag unloading system according to claim 6, wherein the bag moving assembly including at least one infeed conveyor configured to introduce the bulk bag filled with the bulk materials from the loading location onto the bag lifting conveyor on the bag lifting device at the lifting location.

8. The automated bulk bag unloading system according to claim 7, wherein the bag moving assembly including multiple infeed conveyors configured to introduce the bulk bag filled with the bulk materials from the loading location onto the bag lifting conveyor on the bag lifting device at the lifting location.

9. The automated bulk bag unloading system of claim 6, wherein the bag moving assembly including an automatic hopper transfer conveyor positioned in the bag cutting area over the hopper, the automatic hopper transfer conveyor is configured to transfer the bulk bag filled with the bulk materials from the bag lifting device through the bag cutting area over the hopper for cutting open the bottom of the bulk bag with the automated cutting system; and
wherein, the automatic hopper transfer conveyor including a gap, the gap is configured to allow a linear rotating blade to traverse through the automatic hopper transfer conveyor for cutting the bottom of the bulk bag while positioned on the automatic hopper transfer conveyor.

10. The automated bulk bag unloading system of claim 1, wherein the bag moving assembly including a bag stabilizer device configured to secure and move the bulk bag through the bag cutting area over the hopper while the bottom of the bulk bag is being cut open by the automated cutting system and when the bulk materials are discharging out of the bottom of the bulk bag and into the hopper.

11. The automatic bulk bag unloader system of claim 10 further including a frame, the frame is configured to support the bag stabilizer device while securing and moving the bulk bag over the hopper;
the frame including two linear rails configured for supporting the bag stabilizer device with the bulk bag filled with the bulk material over the hopper while moving linearly through the cutting area while the bottom of the bulk bag is being cut open by the automated cutting system and when the bulk materials are discharging out of the bottom of the bulk bag and into the hopper.

12. The automated bulk bag unloading system of claim 10, wherein the bag moving assembly further including an automatic hopper transfer conveyor positioned in the bag cutting area over the hopper, the automatic hopper transfer conveyor and the bag stabilizer device are synchronized together for moving the bulk bag through the bag cutting area over the hopper at a same pace and movement, and for moving the cut open bulk bag off of the automatic hopper transfer conveyor for discharging the bulk materials from the bulk bag into the hopper; and
the automatic hopper transfer conveyor may be sized and positioned between two parallel, stationary rotating blades configured to cut the bottom of the bulk bag while the bottom of the bulk bag is moved over the two parallel, stationary rotating blades via the automatic hopper transfer conveyor and the bag stabilizer device.

13. The automated bulk bag unloading system of claim 10, wherein the bag stabilizer device including:
a top member having a width sized wider than the bulk bag;
a first side bracket extending down from the top member on a first end, the first side bracket including at least one first side puncturing rod, each of the at least one first side puncturing rod is configured to move into and out of the first side bracket of the bag stabilizer device, wherein, when each of the at least one first side puncturing rod is moved into the bag stabilizer device, each of the at least one first side puncturing rod is configured to puncture a first side of the bulk bag for securing and holding the first side of the bulk bag while moving through the bag cutting area over the hopper; and
a second side bracket extending down from the top member on a second end, the second side bracket including at least one second side puncturing rod, each of the at least one second side puncturing rod is configured to move into and back out of the second side bracket of the bag stabilizer device, wherein, when each of the at least one second side puncturing rod is moved into the bag stabilizer device, each of the at least one second side puncturing rod is configured to puncture a second side of the bulk bag for securing and holding the second side of the bulk bag while moving through the bag cutting area over the hopper.

14. The automated bulk bag unloading system of claim 13, wherein:
the first side bracket of the bag stabilizer device including multiple first side puncturing rods in a horizontal diamond shape configuration configured to stabilize the first side of the bulk bag, and each of the four first side puncturing rods including a pointed tip; and
the second side bracket of the bag stabilizer device including multiple second side puncturing rods in the horizontal diamond shape configuration configured to stabilize the second side of the bulk bag, and each of the four second side puncturing rods including the pointed tip.

15. The automatic bulk bag unloader system of claim 13, wherein, when the automated cutting system cuts open the bottom of the bulk bag while in position over the hopper and the bulk materials from the bulk bag automatically emptying into the hopper through the bottom of the bulk bag that is cut open, the bag stabilizer device is configured to move an emptied bulk bag away from over the hopper.

16. The automatic bulk bag unloader system of claim 15, wherein, when the bag stabilizer device moves the emptied bulk bag from over the hopper, the bag stabilizer device is configured to drop the emptied bulk bag by moving each of the at least one first side puncturing rod from the first side of the bulk bag and moving each of the at least one second side puncturing rod from the second side of the bulk bag.

17. The automatic bulk bag unloader system of claim 16 further comprising a bag waste container that is a waste bin, baler or compactor, wherein, when the bag stabilizer device moves the emptied bulk bag from over the hopper, the bag stabilizer device is configured to move the emptied bulk bag over the bag waste container and drop the emptied bulk bag into the bag waste container for disposing, baling or compacting the emptied bulk bag.

18. The automated bulk bag unloading system of claim 1, wherein:
the hopper including a surge hopper, the surge hopper includes the automated cutting system integrally coupled therein, wherein the automated cutting system is configured to cut the bottom of the bulk bag allowing the bulk material to discharge directly into the surge hopper, and wherein the surge hopper is configured to store the bulk material and discharge the bulk material through downstream metering equipment to meet process requirements;
the automated bulk bag unloading system further including a control system, the control system is configured to control the bag moving assembly and the automated cutting system including the at least one automated cutting device of the automated cutting system to ensure the bottom of the bulk bag is opened allowing for discharge of the bulk material from the bottom of the bulk bag;
the automated bulk bag unloading system is fully enclosed for operator safety and/or dust control;
the automated bulk bag unloading system further including a dust collection assembly configured for collecting dust or loose materials from in and around the bulk bag and the bag cutting area before and while being emptied into the hopper; or
combinations thereof.

19. An automated bulk bag unloading system for autonomously unloading bulk materials from a bulk bag into a hopper, the automated bulk bag unloading system comprising:
an automated cutting system positioned over the hopper in the bag cutting area, the automated cutting system including at least one automated cutting device configured to cut open a bottom of the bulk bag filled with the bulk materials while in position over the hopper, wherein the automated cutting system including:
a linear rotating blade configured to cut the bottom of the bulk bag approximate a front edge of the bulk bag from approximate a first side edge of the bulk bag to approximate a second side edge of the bulk bag, the linear rotating blade is mounted on a linear shaft with a drive unit configured to move the linear rotating blade from one side of the bulk bag to the other side of the bulk bag;
two stationary rotating blades configured to cut the bottom of the bulk bag while the bottom of the bulk bag is moved over the two stationary rotating blades, the two stationary rotating blades are parallel, the two stationary rotating blades including:
a first stationary rotating blade configured to cut the bottom of the bulk bag approximate to the first side edge;
a second stationary rotating blade configured to cut the bottom of the bulk bag approximate to the second side edge;
the first stationary rotating blade is parallel with the second stationary rotating blade;
wherein, the automated cutting system is configured to automatically cut three sides of the bottom of the bulk bag thereby creating an openable flap portion of the bottom of the bulk bag;
a bag moving assembly configured to move the bulk bag filled with the bulk materials from a loading location to the bag cutting area above the hopper, the bag moving assembly including:
a bag lifting device at a lifting location, the bag lifting device is configured to elevate the bulk bag to a height of the bag cutting area over the hopper, wherein the bag lifting device including a bag lifting conveyor configured to move the bulk bag filled with the bulk materials onto and off the bag lifting device;
at least one infeed conveyor configured to introduce the bulk bag filled with the bulk materials from the loading location onto the bag lifting conveyor on the bag lifting device at the lifting location;
an automatic hopper transfer conveyor positioned in the bag cutting area over the hopper, the automatic hopper transfer conveyor is configured to transfer the bulk bag filled with the bulk materials from the bag lifting device through the bag cutting area over the hopper for cutting open the bottom of the bulk bag with the automated cutting system, the automatic hopper transfer conveyor including a gap configured to allow the linear rotating blade to traverse through the automatic hopper transfer conveyor for cutting the bottom of the bulk bag while positioned on the automatic hopper transfer conveyor, and the automatic hopper transfer conveyor may be sized and positioned between the two stationary rotating blades configured to cut the bottom of the bulk bag while the bottom of the bulk bag is moved over the two parallel stationary rotating blades via the automatic hopper transfer conveyor and the bag stabilizer device;
a bag stabilizer device configured to secure and move the bulk bag through the bag cutting area over the hopper while the bottom of the bulk bag is being cut open by the automated cutting system and when the bulk materials are discharging out of the bottom of the bulk bag and into the hopper;
wherein the bag stabilizer device including:
a top member having a width sized wider than the bulk bag;
a first side bracket extending down from the top member on a first end, the first side bracket including at least one first side puncturing rod, each of the at least one first side puncturing rod is configured to move into and out of the bag stabilizer device, wherein, when each of the at least one first side puncturing rod is moved into the bag stabilizer device, each of the at least one first side puncturing rod is configured to puncture a first side of the bulk bag for securing and holding the first side of the bulk bag while moving through the bag cutting area over the hopper, the first side bracket of the bag stabilizer device including four first side puncturing rods in a horizontal diamond shape configuration configured to stabilize the first side of the bulk bag, and each of the four first side puncturing rods including a pointed tip;
a second side bracket extending down from the top member on a second end, the second side bracket including at least one second side puncturing rod, each of the at least one second side puncturing rod is configured to move into and back out of the bulk bag stabilizer device, wherein, when each of the at least one second side puncturing rod is moved into the bag stabilizer device, each of the at least one second side puncturing rod is configured to puncture a second side of the bulk bag for securing and holding the second side of the bulk bag while moving through the bag cutting area over the hopper, the second side bracket of the bag stabilizer device including four second side puncturing rods in the horizontal diamond shape configuration configured to stabilize the second side of the bulk bag, and each of the four second side puncturing rods including the pointed tip;
a frame configured to support the bag stabilizer device while securing and moving the bulk bag over the hopper, the frame including two linear rails configured for supporting the bag stabilizer device with the bulk bag filled with the bulk material over the hopper while moving linearly through the cutting area while the bottom of the bulk bag is being cut open by the automated cutting system and when the bulk materials are discharging out of the bottom of the bulk bag and into the hopper;
the automatic hopper transfer conveyor and the bag stabilizer device are synchronized together for moving the bulk bag through the bag cutting area over the hopper at the same pace and movement, and for moving the cut open bulk bag off of the automatic hopper transfer conveyor for discharging the bulk materials from the bulk bag into the hopper;
wherein, when the bag moving assembly moves the bulk bag filled with the bulk materials from the loading location to the bag cutting area over the hopper, and the automated cutting system cuts open the bottom of the bulk bag while in position over the hopper, the bulk materials from the bulk bag discharging out of the bottom of the bulk bag and drop into the hopper;
a bag waste container that is a waste bin, baler or compactor, wherein, when the automated cutting system cuts open the bottom of the bulk bag while in position over the hopper and the bulk materials from the bulk bag automatically empty into the hopper through the bottom of the bulk bag that is cut open, the bag stabilizer device is configured to move an emptied bulk bag from over the hopper, wherein, when the bag stabilizer device moves the emptied bulk bag from over the hopper, the bag stabilizer device is configured to move the emptied bulk bag over the bag waste container and drop the emptied bulk bag into the bag waste container for disposing, baling or compacting the emptied bulk bag;
a control system, the control system is configured to control the bag moving assembly and the automated cutting system including the at least one automated cutting device of the automated cutting system to ensure the bottom of the bulk bag is opened allowing for discharge of the bulk material from the bottom of the bulk bag; and
wherein, the automated bulk bag unloading system is configured to eliminate all operator interface in emptying the bulk bag and allow for discharging of more than 10 of the bulk bags per hour.

20. A method of automatically discharging a bulk bag filled with bulk materials comprising:
providing an automated bulk bag unloading system for autonomously unloading the bulk materials from the bulk bag into a hopper, the automated bulk bag unloading system comprising:
a bag moving assembly configured to move the bulk bag filled with the bulk materials from a loading location to a bag cutting area above the hopper; and
an automated cutting system positioned over the hopper in the bag cutting area, the automated cutting system including at least one automated cutting device configured to cut open a bottom of the bulk bag filled with the bulk materials while in position over the hopper;
moving the bulk bag filled with the bulk materials from the loading location to the bag cutting area over the hopper via the bag moving assembly;
cutting open the bottom of the bulk bag while in position over the hopper via the automated cutting system;
discharging the bulk materials out of the cut open bottom of the bulk bag; and
dropping the bulk materials from the cut open bottom of the bulk bag into the hopper.
